(19) United States
(12) Patent Application Publication
(10) Pub. No.: US 2010/0039769 A1
(43) Pub. Date: Feb. 18, 2010

(54) System unit for a computer

(76) Inventor: Chartchai Saisila, Karlsruhe (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/514,331

(22) PCT Filed: Nov. 12, 2007
(86) PCT No.: PCT/EP07/62211

§ 371 Date: May 11, 2009

(30) Foreign Application Priority Data
Nov. 13, 2006 (DE) 10 2006 053 412.3

(51) Int. Cl. G06F 1/16

(52) U.S. Cl. 361/679.58

(57) ABSTRACT

A system unit for a computer is disclosed, provided on one wall with a pivoting front flap and a cover which is locked with a closed front flap and unlocked with an open front flap. A rotatably mounted lock is provided, into the bearing of which a joint pin engages, by means of which the front flap is pivotably mounted and, on closing the front flap, the above presses on a bolt of the lock whereupon the lock rotates such that a catch of the lock locks the cover.

### CROSS REFERENCE TO RELATED APPLICATIONS

This application is the US National Stage of International Application No. PCT/EP2007/062211 filed Nov. 12, 2007 and claims the benefit thereof. The International Application claims the benefits of German Patent Application No. 10 2006 053 412.3 DE filed Nov. 13, 2006, both of the applications are incorporated by reference herein in their entirety.

### FIELD OF INVENTION

The invention relates to a system unit for a computer, said system unit being provided on one wall with a swivel-mounted front flap and with a cover which is locked when the front flap is closed and unlocked when the front flap is open.

### BACKGROUND OF INVENTION

A system unit of the aforesaid kind is known from the Siemens ST PC Catalog, Edition 2006, pages 2/4 and 2/5. An operator input unit, e.g. an operator input unit in the form of a keyboard and/or a mouse, as well as at least one image reproducing device and other hardware units can be connected to said system unit in the form of a rack PC. Moreover, the rack PC is provided with further hardware means that are suitable for operation of the computer, with interfaces as well as floppy disk and/or hard disk drives being disposed in a recess which can be closed by means of a swivel-mounted front flap. Additionally provided on the front side is a swivel-mounted fan cover which is locked when the front flap is closed and unlocked when the front flap is open. For that purpose a swivel-mounted edge region of the front flap is embodied in such a way that it completely covers an edge region of the fan cover when the front flap is closed and consequently the fan cover is not locked.

### SUMMARY OF INVENTION

An object of the present invention is to provide a system unit of the type cited in the introduction by means of which locking the cover is simplified.

This object is achieved in that a rotatably mounted lock is provided, into the bearing of which engages a hinge pin by means of which the front flap is swivelably mounted, and in that when the front flap is closed it presses on a driver of the lock, as a result of which the lock rotates such that a catch of the lock locks the cover.

In one embodiment of the invention the hinge pin and the lock are disposed in a frame, wherein the catch and the driver each project from a cutout in the frame. As a result of this arrangement no additional space is required for installing the lock.

In a further embodiment of the invention the lock has a return spring. When the front flap is opened, said spring rotates the lock in such a way that the cover is unlocked automatically.

A further advantageous embodiment of the invention will emerge from the further dependent claims.

### BRIEF DESCRIPTION OF THE DRAWINGS

The invention, its embodiments and advantages are explained in more detail below with reference to the drawing, in which an exemplary embodiment of the invention is illustrated.

FIG. 1 shows a system unit of a computer,

FIGS. 2 and 3 show views of a front side of a system unit, and

FIG. 4 shows a lock.

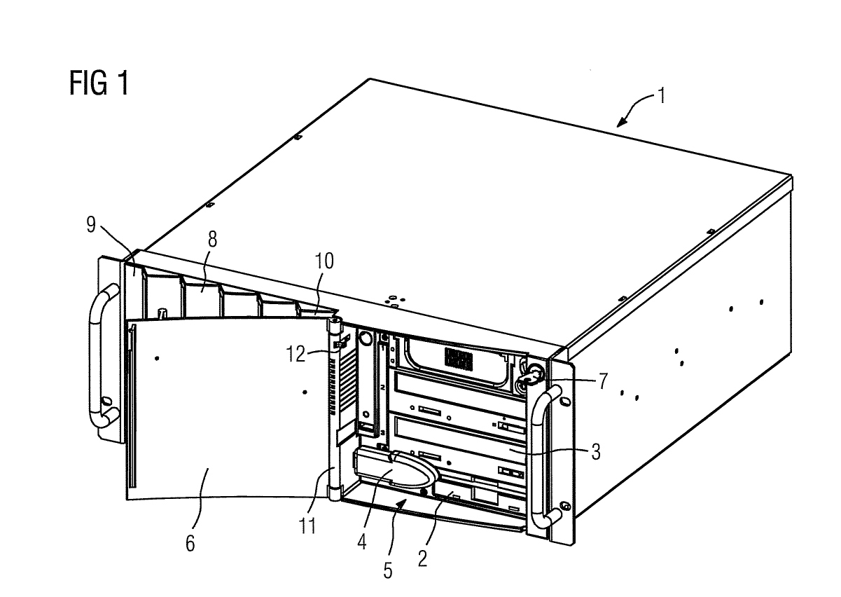

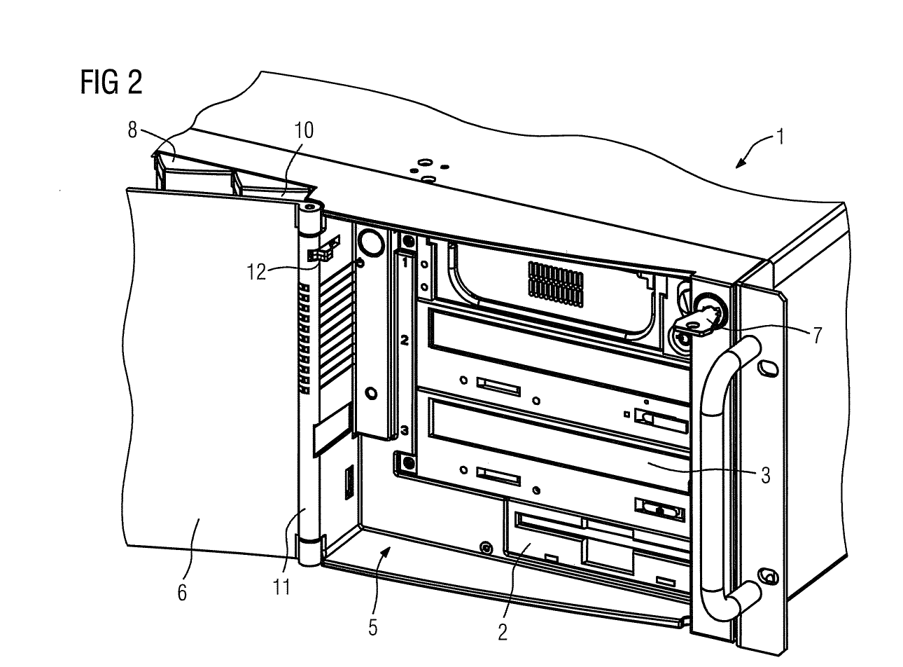

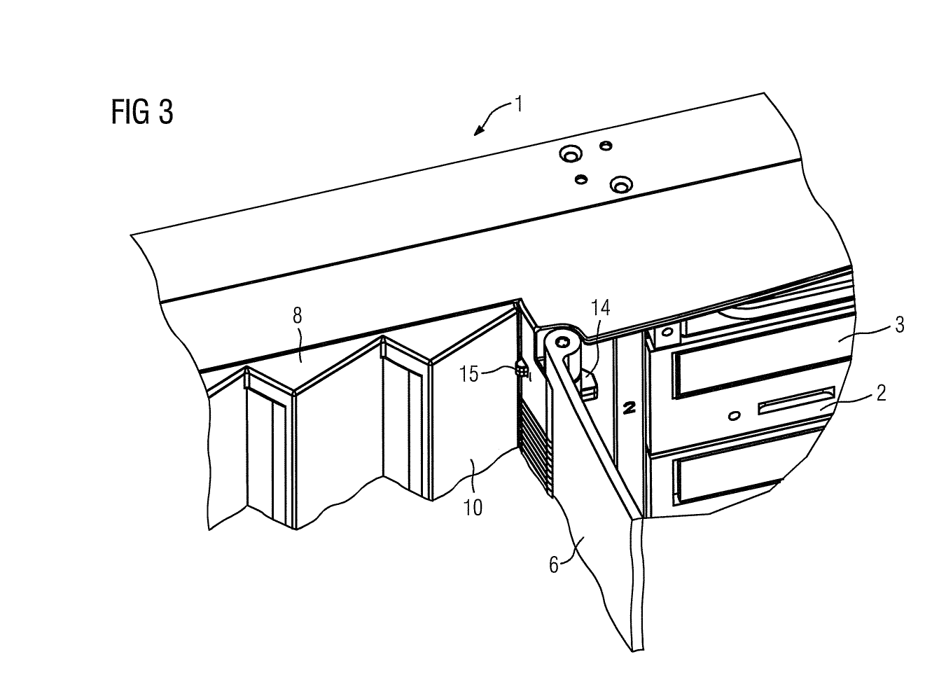

The same parts shown in FIGS. 1 to 4 are labeled with the same reference signs.

### DETAILED DESCRIPTION OF INVENTION

In FIG. 1, a system unit of a computer is designated by 1. Operator input units, e.g. operator input units in the form of a keyboard and/or a mouse, as well as at least one image reproducing device and further hardware units can be connected to said system unit 1. The system unit 1 is additionally provided with what are termed PCI plug-in cards (not shown here) which are plugged into slots of a motherboard. Further component parts of the system unit 1, such as, for example, floppy disk or hard disk drives 2, 3, power supply unit or other hardware means suitable for the operation of the computer, are of no relevance as far as the invention is concerned and consequently are not explained.

In the present exemplary embodiment the floppy disk or hard disk drives 2, 3 and a USB stick 4 are disposed in a recess 5 which can be covered by means of a swivel-mounted front flap 6 and closed by means of a key 7 having a suitable locking mechanism. On the front side the system unit 1 is additionally provided with a fan cover 8 whose first frame region 9 hooks into the system unit 1 and whose second frame region 10 latches by means of a snap fit into the system unit 1.

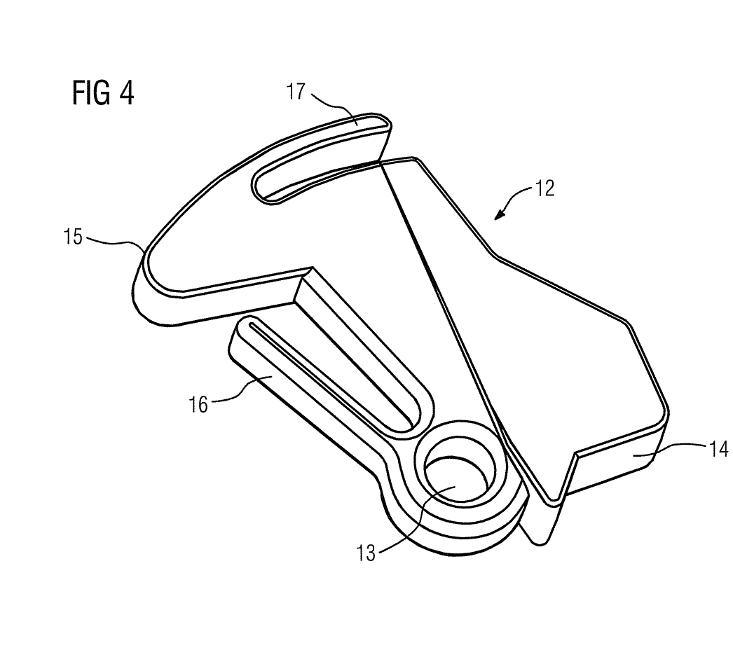

In order to prevent the possibility of the snap-in connection being released with the front flap 6 closed and the fan cover 8 being removed from the system unit 1, there is disposed in a frame 11 of the system unit 1 a rotatable lock 12 into the bearing 13 (FIG. 4) of which a hinge pin (not shown) engages by means of which the front flap 6 is swivel-mounted. When the front flap 6 is closed, it presses onto a driver 14, as a result of which the lock 12 rotates in such a way that a catch 15 of the lock 12 locks the fan cover 8. In the present exemplary embodiment, when the front flap 6 is closed the lock 12 rotates counterclockwise, thereby causing the catch 15 to move over the frame region 10 of the fan cover 8, as a result of which the snap-in connection of said frame region 10 of the fan cover 8 cannot be released and the fan cover 8 is thereby blocked and cannot be removed from the system unit 1. The fan cover 8 is unlocked by opening the front flap 6. This causes a return spring 16 of the lock 12 in the frame 11 to generate a turning moment in the clockwise direction and the catch 15 to move in the direction of the cutout in the frame 11. This means that the catch 15 moves away from the frame region 10 of the fan cover 8 in the direction of the frame 11, thereby unlocking the fan cover 8 and enabling it to be removed from the system unit 1. In order to be able to introduce and install the lock easily into a cutout of the frame 11, the lock 12 has a mounting spring 17. The installation is carried out in such a way that the catch 15 is introduced into the cutout of the frame 11 up to the point where the mounting spring 17 stops it from being inserted any further. In this position the hinge pin can be inserted into the frame 11 and into the bearing 13 of the lock 12, a part of the hinge pin projecting beyond the frame 11 and being provided for swivel-mounting the front flap 6.

1.-4. (canceled)

5. A system unit for a computer, comprising:
a swivel-mounted front flap, the system unit being provided on a wall with the swivel-mounted front flap;
a cover which is locked when the front flap is closed and unlocked when the front flap is open;
a rotatably mounted lock having a bearing, a catch and a driver; and
a hinge pin engaging into the bearing, the front flap being swivel-mounted by the hinge pin, wherein
the front flap presses onto the driver when the front flap is closed resulting in that the lock rotates such that the catch locks the cover.

6. The system unit as claimed in claim 5, further comprising:
a frame, wherein the hinge pin and the rotatably mounted lock are disposed in the frame and the catch and the driver each project from a cutout in the frame.

7. The system unit as claimed in claim 5, wherein the rotatably mounted lock has a return spring which, when the front flap is opened, rotates the lock such that the cover is unlocked.

8. The system unit as claimed in claim 6, wherein the rotatably mounted lock has a return spring which, when the front flap is opened, rotates the lock such that the cover is unlocked.

9. The system unit as claimed in claim 6, wherein the rotatably mounted lock has a mounting spring.

10. The system unit as claimed in claim 7, wherein the rotatably mounted lock has a mounting spring.

11. The system unit as claimed in claim 8, wherein the rotatably mounted lock has a mounting spring.
